(19) United States
(12) Patent Application Publication
(10) Pub. No.: US 2023/0133519 A1
(43) Pub. Date: May 4, 2023

(54) IMAGE PROCESSING METHOD

(71) Applicant: NEC Corporation, Minato-Ku, Tokyo (JP)

(72) Inventors: Azusa Sawada, Tokyo (JP); Kenta Senzaki, Tokyo (JP); Takashi Shibata, Tokyo (JP); Takashi Shibata, Tokyo (JP)

(73) Assignee: NEC Corporation, Minato-Ku, Tokyo (JP)

(21) Appl. No.: 17/918,156

(22) PCT Filed: Apr. 17, 2020
(86) PCT No.: PCT/JP2020/016962

§ 371 Date: Oct. 11, 2022

(51) Int. Cl. G06V 10/26; G06V 10/28; G06V 10/20; G06V 10/60; G01S 13/90

(52) U.S. Cl. CPC G06V 10/273; G06V 10/28; G06V 10/255; G06V 10/60; G01S 13/9029; G06V 20/52

(57) ABSTRACT

An image processing device 100 of the present invention includes an image generation means 121 for generating a difference image representing a difference between an object image that is an image including an area from which a mobile body is to be detected and a corresponding image that is another image including an area corresponding to the area of the object image, and a detection means 122 for detecting the mobile body from the object image on the basis of the object image, the corresponding image, and the difference image.

### TECHNICAL FIELD

The present invention relates to an image processing method, an image processing system, and a program.

### BACKGROUND ART

Marine surveillance is performed by detecting sea-going vessels with use of captured image such as satellite images. In particular, by using synthetic aperture radar (SAR) images in which a ground surface is imaged from a high altitude as captured images, it is possible to perform marine surveillance not affected by the weather.

Patent Literature 1 discloses an example of detecting a vessel by using an SAR image. In the art disclosed in Patent Literature 1, a captured image is binarized and an area with high luminance is extracted as a candidate vessel.

Patent Literature 1: JP 2019-175142 A

### SUMMARY

However, in the art disclosed in Patent Literature 1, there is a problem that a vessel coming alongside a land cannot be detected with high accuracy due to an interference with an object provided on the land. That is, on a land that a vessel comes alongside, since there is an object on the land such as a bridge or a crane, a vessel cannot be detected with high accuracy due to an interference with such an object. Specifically, when an object on the land has high luminance, it is difficult to appropriately set a luminance value serving as a threshold for binarization, which causes a case where an object on the land and a vessel are not distinguishable from each other with high accuracy. Moreover, there is a case where an object on the land may be erroneously detected as a vessel. This causes a problem that detection may not be performed with high accuracy not only in the case of detecting a vessel and the case of the water area in a captured image, but also in the case of detecting a mobile body located in a specific area.

In view of the above, an object of the present invention is to provide an image processing method, an image processing system, and a program capable of solving the above-described problem, that is, a mobile body in a captured image cannot be detected with high accuracy.

An image processing method, according to one aspect of the present invention, is configured to include
generating a difference image representing a difference between an object image that is an image including an area from which a mobile body is to be detected and a corresponding image that is another image including an area corresponding to the area of the object image, and
detecting the mobile body from the object image on the basis of the object image, the corresponding image, and the difference image.

Further, an image processing device, according to one aspect of the present invention, is configured to include
an image generation means for generating a difference image representing a difference between an object image that is an image including an area from which a mobile body is to be detected and a corresponding image that is another image including an area corresponding to the area of the object image, and
a detection means for detecting the mobile body from the object image on the basis of the object image, the corresponding image, and the difference image.

Further, a program, according to an aspect of the present invention, is configured to cause an information processing device to realize
an image generation means for generating a difference image representing a difference between an object image that is an image including an area from which a mobile body is to be detected and a corresponding image that is another image including an area corresponding to the area of the object image, and
a detection means for detecting the mobile body from the object image on the basis of the object image, the corresponding image, and the difference image.

With the configurations described above, the present invention can detect a mobile body in a captured image with high accuracy.

### BRIEF DESCRIPTION OF DRAWINGS

FIG. 1 is a block diagram illustrating a configuration of an image processing device according to a first exemplary embodiment of the present invention.

FIG. 2 illustrates a state of image processing by the image processing device disclosed in FIG. 1.

FIG. 3 illustrates a state of image processing by the image processing device disclosed in FIG. 1.

FIG. 4 illustrates a state of image processing by the image processing device disclosed in FIG. 1.

FIG. 5 illustrates a state of image processing by the image processing device disclosed in FIG. 1.

FIG. 6 illustrates a state of image processing by the image processing device disclosed in FIG. 1.

FIG. 7 is a flowchart illustrating an operation of the image processing device disclosed in FIG. 1.

FIG. 8 is a block diagram illustrating a hardware configuration of an image processing device according to a second exemplary embodiment of the present invention.

FIG. 9 is a block diagram illustrating a configuration of the image processing device according to the second exemplary embodiment of the present invention.

FIG. 10 is a flowchart illustrating an operation of the image processing device according to the second exemplary embodiment of the present invention.

### EXEMPLARY EMBODIMENTS

### First Exemplary Embodiment

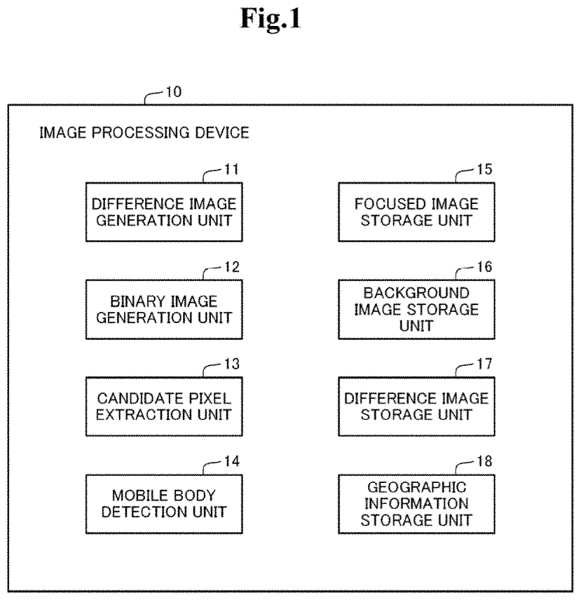

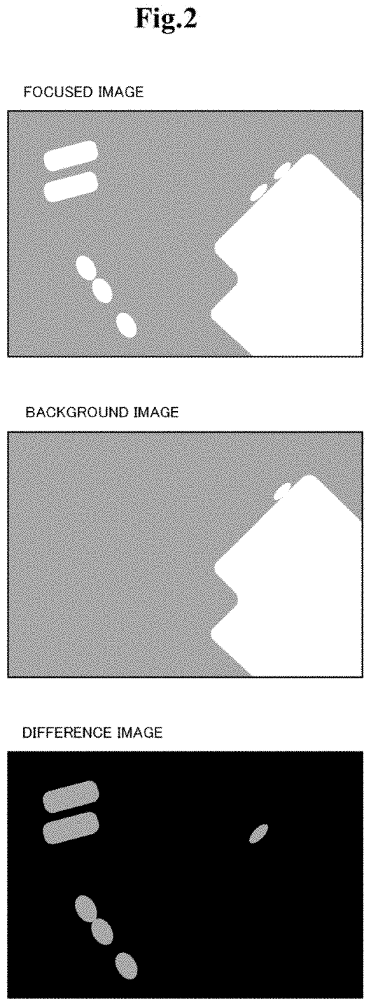

A first exemplary embodiment of the present invention will be described with reference to FIGS. 1 to 7. FIG. 1 is a diagram for explaining a configuration of an image processing device, and FIGS. 2 to 7 are diagrams for explaining the processing operation of the image processing device.

### [Configuration]

An image processing device 10 of the present embodiment is for detecting a sea-going vessel in order to perform marine surveillance from captured images such as satellite images captured using a synthetic aperture radar (SAR). However, the image processing device 10 does not necessarily image an area on the sea, but may image any area. Moreover, the image processing device 10 is not limited to detecting a vessel from a captured image, but may detect any mobile body. For example, the image processing device 10 may image an area such as an airport and detect a mobile body such as an aircraft. Furthermore, an image to be processed by the image processing device 10 is not limited to a satellite image captured using an SAR, but may be any image.

The image processing device 10 is configured of one or a plurality of information processing devices each having an arithmetic device and a storage device. As illustrated in FIG. 1, the image processing device 10 includes a difference image generation unit 11, a binary image generation unit 12, a candidate pixel extraction unit 13, and a mobile body detection unit 14. The respective functions of the difference image generation unit 11, the binary image generation unit 12, the candidate pixel extraction unit 13, and the mobile body detection unit 14 can be implemented through execution, by the arithmetic unit, of a program for implementing the respective functions stored in the storage device. The image processing device 10 also includes a focused image storage unit 15, a background image storage unit 16, a difference image storage unit 17, and a geographic information storage unit 18. The focused image storage unit 15, the background image storage unit 16, the difference image storage unit 17, and the geographic information storage unit 18 are configured of a storage device. Hereinafter, the respective constituent elements will be described in detail.

The focused image storage unit 15 stores therein a focused image (object image) that is an image of a sea that is an area (object area) from which a vessel that is a mobile body is detected. A focused image is a satellite image captured using an SAR as illustrated in the upper drawing of FIG. 2, and is mainly an image of the sea, but includes a land adjacent to the sea, or an object provided on the land. Regarding the luminance values of pixels in the focused image, pixels of a land, an object on the land, and a vessel take high luminance values, and pixels of a water area that is sea take low luminance values. Since a focused image is a satellite image, it is associated with position information such as latitude and longitude on the earth based on information such as an orbit of the satellite and the setting of the imaging device.

The background image storage unit 16 stores therein a background image that is a satellite image captured by using an SAR as similar to the focused image, and is an image of an area corresponding to the object area of the focused image, that is, the sea that is an area almost the same as the object area. In particular, a background image is a captured image at the time when there is no vessel moving in the object area such as the sea. Therefore, a background image is configured of an image captured in a time period when there is no vessel in the object area, or an image in which image processing of removing a mobile body, that is, a vessel, is performed on a plurality of past images of the object area. For example, a background image is generated by performing positioning of a plurality of past captured images of the object area and selecting a minimum value for each pixel to thereby remove pixels of high luminance values that may be determined to be a vessel, as described below. Since a background image is a satellite image itself or generated from a satellite image, it is associated with position information such as latitude and longitude on the earth based on information such as an orbit of the satellite and the setting of the imaging device.

The difference image storage unit 17 stores therein a difference image representing a difference between the focused image and the background image. Specifically, a difference image is an image in which a difference between luminance values of pixels corresponding to each other in the focused image and the background image is generated as a new pixel value, as described below. Therefore, as illustrated in the lower drawing of FIG. 2 for example, in the difference image, a portion of the focused image having a change in the luminance value relative to the background image takes a high luminance value, so that a portion where a mobile body is not present in the background image but is present in the focused image is particularly represented by a high luminance value relative to the surroundings. Since a difference image is generated from a focused image and a background image that are satellite images, it is associated with position information such as latitude and longitude on the earth based on information such as an orbit of the satellite and the setting of the imaging device.

The geographic information storage unit 18 stores therein map information of an object area where the focused image and the background image are captured. In particular, map information includes position information of a land of the object area, and includes position information such as latitude and longitude on the earth of the land, for example.

The difference image generation unit 11 (image generation means) reads out, from the focused image storage unit 15, a focused image captured at a predetermined time that is a processing object from which a vessel is to be detected, reads out a background image from the background image storage unit 16, generates a difference image from the focused image and the background image, and stores it in the difference image storage unit 17. For example, the difference image generation unit 11 performs positioning of the focused image illustrated in the upper drawing of FIG. 2 and the background image illustrated in the center drawing of FIG. 2, on the basis of the position information, the similarity in the topography in the images, and the like, and calculates a difference between the luminance values of pixels corresponding to each other. Then, the difference image generation unit 11 generates a difference image as illustrated in the lower drawing of FIG. 2 by using the difference as a new pixel value. Therefore, the generated difference image is an image in which a portion in the focused image where the luminance value has a change relative to the background image, that is, a portion of a mobile body in particular, is indicated by a higher luminance value relative to the surroundings. However, the difference image may be generated by a method other than that described above. For example, in the case of using a combination of a focused image and a background image that are not captured on the same orbit by the satellite, it is possible to generate a difference image by applying a technique enabling extraction of a change excluding a distortion difference on an image for each orbit and performing positioning of the focused image and the background image.

Note that the difference image generation unit 11 may have a function of generating a background image to be used for generating a difference image. In that case, the difference image generation unit 11 generates a background image by acquiring past captured images of the object area previously stored in the background image storage unit 16, performing positioning on those captured images on the basis of the position information, similarity of the topography in the images, and the like, and selecting a minimum value for each pixel to thereby remove pixels having high luminance values that may be determined as a vessel. However, a background image may be generated by any method.

The binary image generation unit 12 (detection means) performs processing to binarize each of the focused image, the background image, and the difference image. At that time, the binary image generation unit 12 determines a threshold of a luminance value for binarization in each image. In the below description, a threshold setting process by the binary image generation unit 12 will be described first.

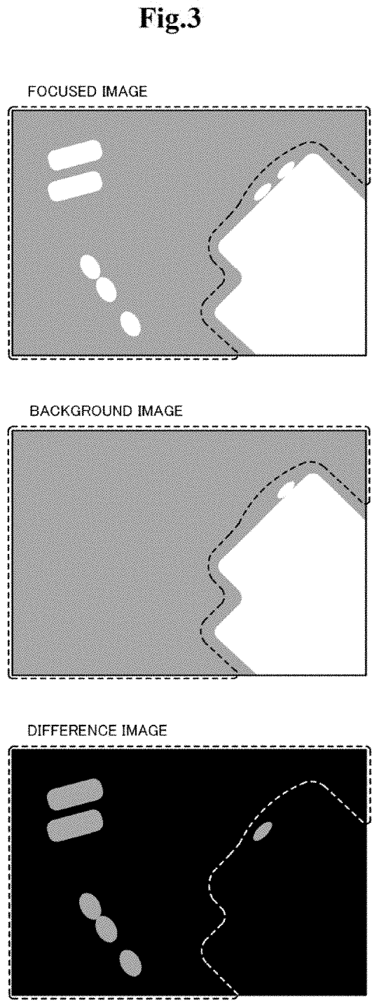

The binary image generation unit 12 first uses the geographic information stored in the geographic information storage unit 18 to set a water area (specific area) on the focused image. Specifically, the binary image generation unit 12 specifies a land area (exclusion area) representing the position of the land on the focused image, from the position information included in the focused image and the geographic information including the position information of the land. Then, the binary image generation unit 12 sets an extended land area (extended exclusion area) that is obtained by extending the edge of the land adjacent to the water area in the land area by a predetermined distance to the water area side. For example, the binary image generation unit 12 sets the extended land area by extending the edge of the land area adjacent to the water area to the water area side by 20 pixels in the focused image, that is, by 20 m in the object area. Then, the binary image generation unit 12 excludes the extended land area from the object area of the entire focused image and sets the remaining area as a water area. Thereby, the binary image generation unit 12 sets the water area on the focused image as indicated by an area surrounded by a dotted line in the upper drawing of FIG. 3.

As similar to the above description, the binary image generation unit 12 sets a water area on the background image as illustrated by an area surrounded by a dotted line in the center drawing of FIG. 3, and sets a water area in the difference image as illustrated by an area surrounded by a dotted line in the lower drawing of FIG. 3. In this manner, even if an object on the land is not completely included in the land area according to the accuracy of the land area (exclusion area) described above, a water area of a predetermined area located adjacent to the land is excluded as an extended land area. Therefore, it is possible to set a water area in which a bridge installed on a land or an object on the land such as a crane are excluded. However, the binary image generation unit 12 is not necessarily limited to set a water area by setting an extended land area as described above. The binary image generation unit 12 may set a water area by simply excluding the land area from the object area, or may set a water area by means of another method.

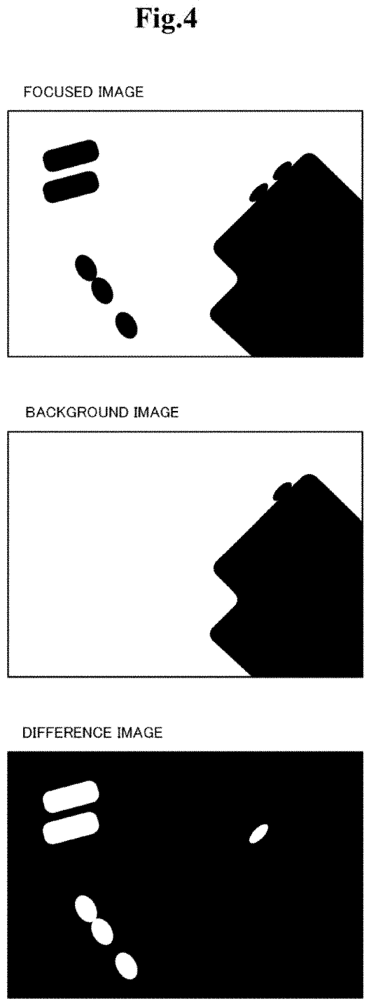

Then, the binary image generation unit 12 generates distribution of luminance values of pixels of a water area set in each of the focused image, the background image, and the difference image, and from the distribution, sets a threshold of luminance values for binarization. Specifically, for a focused image, the binary image generation unit 12 first generates distribution of luminance values of all pixels in the area set as a water area to be surrounded by a dotted line in the upper drawing of FIG. 3. At that time, for example, the binary image generation unit 12 generates distribution of the luminance values of the pixels by approximating the distribution of the luminance values to a function. Then, from the generated distribution, the binary image generation unit 12 sets a threshold of luminance values for binarizing the focused image. In particular, the binary image generation unit 12 sets a threshold of luminance values with which luminance values of the sea that can be considered as a water area and luminance values that can be considered as an object existing in the water area are distinguishable from each other, in the water area in the focused image. Then, the binary image generation unit 12 uses the threshold set for the focused image to generate a binary image (transformed image) in which the luminance value of each pixel in the entire focused image is binarized. Thereby, the binary image generation unit 12 generates a binary image as illustrated in the upper drawing of FIG. 4 from the focused image.

Then, the binary image generation unit 12 also performs, on the background image and the difference image, the same processing as that performed on the focused image, and generates binary images respectively. Specifically, for the background image, the binary image generation unit 12 generates distribution of luminance values of all pixels in the area set as a water area surrounded by a dotted line in the center drawing of FIG. 3, and from the distribution, sets a threshold of the luminance values for binarizing the background image, and generates a binary image as illustrated in the center drawing of FIG. 4 from the background image by using such a threshold. At that time, the binary image generation unit 12 sets a threshold of luminance values with which the luminance values of the sea that can be considered as a water area and the luminance values that can be considered as an object existing in the water area are distinguishable from each other, in the water area in the background image. Furthermore, for the difference image, the binary image generation unit 12 generates distribution of luminance values of all pixels in the area set as a water area surrounded by a dotted line in the lower drawing of FIG. 3, and from the distribution, sets a threshold of the luminance values for binarizing the difference image, and generates a binary image as illustrated in the lower drawing of FIG. 4 from the difference image by using such a threshold. At that time, the binary image generation unit 12 sets a threshold of luminance values with which the luminance values of the sea that can be considered as a water area and the luminance values that can be considered as an object existing in the water area are distinguishable from each other, in the water area in the difference image. Thereby, the binary image of the difference image becomes a binary image in which a pixel having a change in the luminance value and a pixel having no change in the luminance value between the focused image and the background image, that is, a pixel that can be considered as a water area and a pixel that can be considered as an object existing in the water area, are distinguishable from each other.

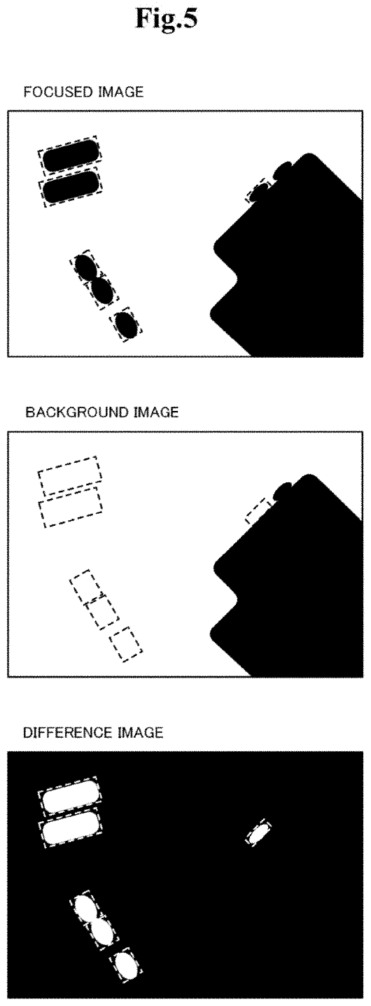

The candidate pixel extraction unit 13 (detection means) extracts a pixel of a candidate vessel by using the binary images of the focused image, the background image, and the difference image generated as described above. At that time, the candidate pixel extraction unit 13 determines, for each binary image, whether or not each pixel is a water area (specific area), and extracts a pixel that is a candidate vessel on the basis of the determination result of each binary image. For example, when the focused pixel satisfies that there is a change in the pixel values, that is, that pixel is not a water area in the binary image of the focused image, it is a water area in the binary image of the background image, and it is not a water area in the binary image of the difference image, the candidate pixel extraction unit 13 extracts it as a pixel of a candidate vessel. As a result, the pixels of the areas surrounded by the rectangles of the dotted lines in FIG. 5 are extracted as candidate vessels.

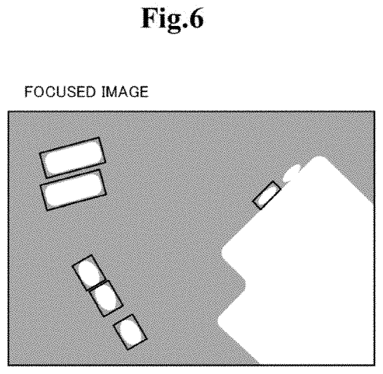

The mobile body detection unit 14 (detection means) detects a mobile body that is a vessel located on the focused image, on the basis of the pixels extracted as a candidate vessel as described above. For example, the mobile body detection unit 14 generates a figure configured of a plurality of pixels on the basis of the distance between the pixels extracted as a candidate vessel. For example, when the pixels extracted as a candidate vessel are adjacent to each other or located within a range of a certain distance, the mobile body detection unit 14 puts a set of the pixels into one figure. Then, the mobile body detection unit 14 compares, for example, the generated figure with a template indicating the shape of a vessel prepared in advance, and when determining that the generated figure is almost the same as the template, detects the generated figure as a vessel. Then, as illustrated in FIG. 6, the mobile body detection unit 14 detects that a while figure surrounded by a rectangle of a solid line as a vessel in the focused image. Note that a plurality of determination criteria may be set for a set of pixels to be generated as one figure, depending on the vessel size.

### [Operation]

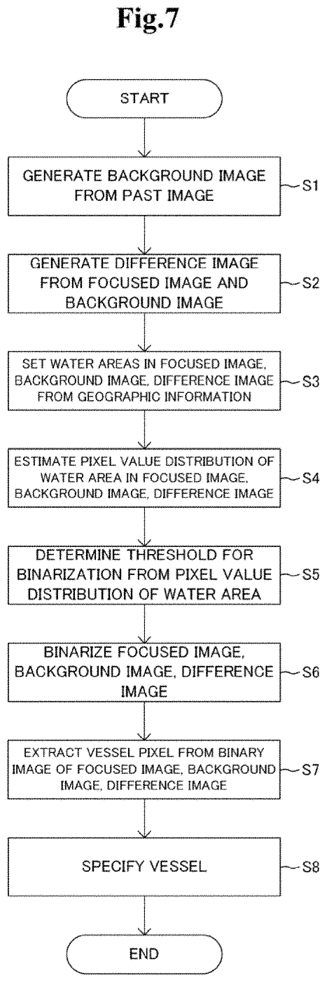

Next, operation of the image processing device 10 as described above will be described with mainly reference to the flowchart of FIG. 7. First, in the image processing device 10, a plurality of past images of an object area captured in advance are stored in the background image storage unit 16, and a focused image in which an object area for detecting a vessel is captured is stored in the focused image storage unit 15. Moreover, in the image processing device 10, geographic information including position information of a land in the object area is stored in the geographic information storage unit 18.

First, the image processing device 10 acquires a plurality of past captured images of an object area previously stored in the background image storage unit 16. Then, the image processing device 10 performs positioning on the captured images on the basis of the position information, selects a minimum value for each pixel to remove pixels having high luminance values that may be determined as a vessel to thereby generate a background image, and stores it in the background image storage unit 16 (step S1). For example, the image processing device 10 generates a background image as illustrated in the center drawing of FIG. 2. Note that the process of generating a background image may not be performed, and may previously store an image determined that a mobile body such as a vessel is not present, as a background image.

Then, the image processing device 10 reads out, from the focused image storage unit 15, a focused image as illustrated in the upper drawing of FIG. 2 that is captured at a predetermined time and is an object of processing to detect a vessel, and also reads out a background image as illustrated in the center drawing of FIG. 2 from the background image storage unit 16. Then, the image processing device 10 calculates a difference between the luminance values of the pixels corresponding to each other from the focused image and the background image, generates a difference image by using the difference as a new pixel value, and stores it in the difference image storage unit 17 (step S2). For example, the image processing device 10 generates a difference image as illustrated in the lower drawing of FIG. 2.

Then, the image processing device 10 sets a water area in each of the focused image, the background image, and the difference image (step S3). For example, regarding the focused image, the image processing device 10 specifies a land area representing the position of the land on the focused image by using the geographic information stored in the geographic information storage unit 18, and sets an extended land area by extending the edge adjacent to the water area of the land area by a predetermined distance to the water area side. Then, the image processing device 10 excludes the extended land area from the object area of the entire focused image, and sets the remaining area as a water area. Thereby, the image processing device 10 sets the water area on the focused image as indicated by an area surrounded by the dotted line in the upper drawing of FIG. 3 for example. Similarly, the image processing device 10 sets water areas on the background image and the difference image as indicated by the dotted line in the center drawing of FIG. 3 and the dotted line in the lower drawing of FIG. 3, respectively.

Then, the image processing device 10 generates distribution of the luminance values of the pixels in the water area for each water area set in the focused image, the background image, and the difference image (step S4). For example, the image processing device 10 generates distribution of the luminance values of the pixels by approximating the distribution of the luminance values to a function. Then, from the distribution generated for each of the focused image, the background image, and the difference image, the image processing device 10 sets a threshold of a luminance value for binarizing each image (step S5). For example, for each of the focused image, the background image, and the difference image, the image processing device 10 sets a threshold of luminance values with which the luminance values of the sea that can be considered as a water area and the luminance values that can be considered as an object existing in the water area are distinguishable from each other. Regarding the difference image, it can be said to set a threshold of luminance values with which the pixels having no change and the pixels with a change between the focused image and the background image are distinguishable from each other.

Then, for each of the focused image, the background image, and the difference image, the image processing device 10 generates a binary image in which the luminance value of each pixel is binarized by using a threshold set for each image (step S6). As a result, the image processing device 10 generates binary images as illustrated in the upper drawing, the center drawing, and the lower drawing of FIG. 4 from the focused image, the background image, and the difference image, respectively.

Then, the image processing device 10 extracts a pixel that is a candidate vessel by using the binary images of the focused image, the background image, and the difference image generated as described above (step S7). For example, the image processing device 10 determines, for each binary image, whether or not each pixel is a water area, and extracts a pixel that is a candidate vessel on the basis of the determination result of each binary image. In particular, in the present embodiment, when the focused pixel satisfies that there is a change in the pixel values, that is, the pixel is not a water area in the binary image of the focused image, it is a water area in the binary image of the background image, and it is not a water area in the binary image of the difference image, the image processing device 10 extracts it as a pixel of a candidate vessel. As a result, the pixels in the areas surrounded by the rectangles of dotted lines in FIG. 5 are extracted as candidate vessels.

Then, the image processing device 10 detects a mobile body that is a vessel located on the focused image, on the basis of the pixels extracted as a candidate vessel as described above (step S8). For example, the image processing device 10 generates a figure configured of a plurality of pixels on the basis of a distance between the pixels extracted as a candidate vessel, and when the figure satisfies the criterion such as a template, the image processing device 10 detects it as a vessel. For example, as illustrated in FIG. 6, the image processing device 10 detects that a while figure surrounded by a rectangle of a solid line as a vessel in the focused image.

As described above, in the present embodiment, by using an object image from which a mobile body that is a vessel is to be detected, a background image, and a difference image thereof, it is possible to suppress an influence of a land and an object on the land and to detect a vessel with high accuracy. In particular, in the present embodiment, a vessel can be detected with high accuracy by using binary images of an object image, a background image, and a difference image, performing binarization by using distribution of luminance values of a water area set to each of the object image, the background image, and the difference image, and setting a water area in which an expended land is removed at that time.

In the above description, an example in which the image processing device 10 detects a vessel appearing in the focused image has been provided. However, it is possible to detect various vessels by changing the criteria for extracting a pixel as a candidate vessel in the candidate pixel extraction unit 13. For example, by changing the criterion for extracting a candidate vessel in the candidate pixel extraction unit 13, it is possible to detect a vessel lost in the background image, that is, a vessel that is at anchor in the background image but is lost in the focused image. In that case, when the focused pixel satisfies that there is a change in the pixel value, that is, the pixel is a water area in the binary image of the focused image, it is not a water area in the binary image of the background image, and it is not a water area in the binary image of the difference image, the candidate pixel extraction unit 13 extracts it as a pixel of a candidate for a lost vessel.

Moreover, the image processing device 10 can cope with detection of any mobile body in any area without being limited to detection of a vessel on the sea that is a water area. For example, the image processing device 10 may image an area such as an airport and detect a mobile body such as an aircraft. In that case, the above-described water area (specific area) is exchanged with a paved ground. This means that the binary image generation unit 12 sets an area of a paved ground instead of a water area as illustrated by a dotted line in FIG. 3, from each of the focused image, the background image, and the difference image. Then, the binary image generation unit 12 generates distribution of luminance values of the area of the paved ground, determines a threshold for binarization, and generates a binary image of each of the focused image, the background image, and the difference image. Then, when the focused pixel satisfies that there is a change in the pixel value, that is, the focused pixel is not a paved ground in the binary image of the focused image, it is a paved ground in the binary image of the background image, and it is not a paved ground in the binary image of the difference image, the candidate pixel extraction unit 13 extracts it as a pixel of a candidate for a an aircraft.

### Second Exemplary Embodiment

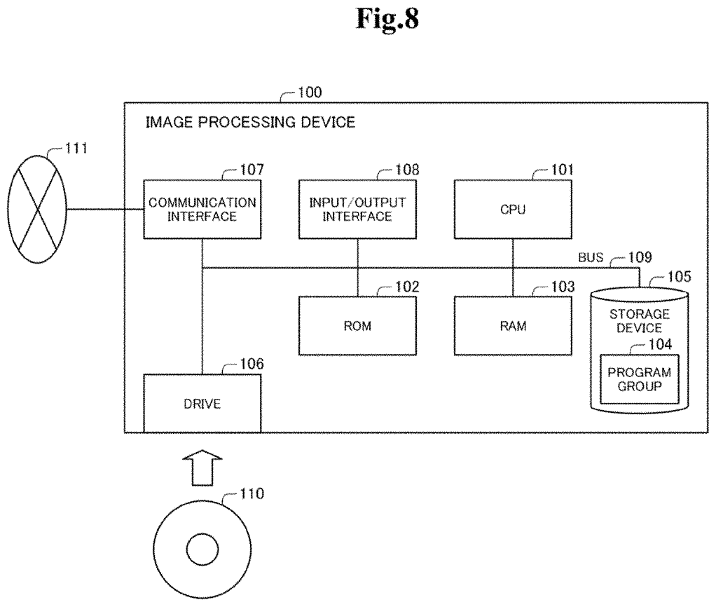

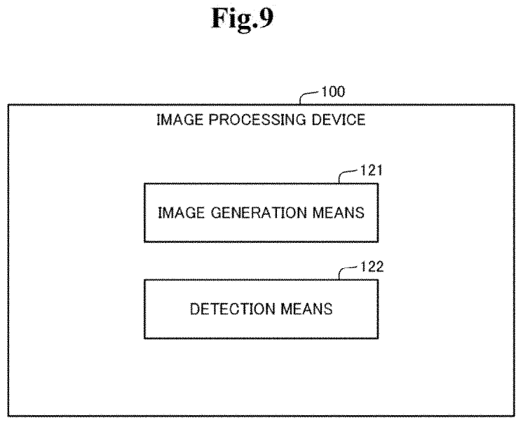

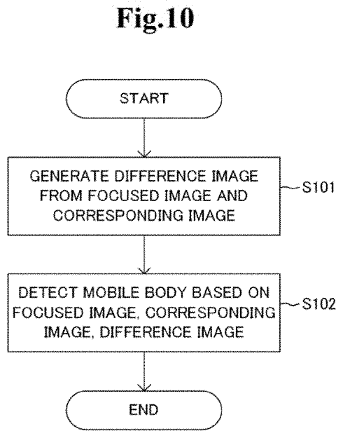

Next, a second exemplary embodiment of the present invention will be described with reference to FIGS. 8 to 10. FIGS. 8 and 9 are block diagrams illustrating a configuration of an image processing device according to the second exemplary embodiment, and FIG. 10 is a flowchart illustrating an operation of the image processing device. Note that the present embodiment shows the outlines of the configurations of the image processing device and the image processing method described in the embodiment described above.

First, a hardware configuration of an image processing device 100 in the present embodiment will be described with reference to FIG. 8. The image processing device 100 is configured of a typical information processing device, having a hardware configuration as described below as an example.
Central Processing Unit (CPU) 101 (arithmetic unit)
Read Only Memory (ROM) 102 (storage device)
Random Access Memory (RAM) 103 (storage device)
Program group 104 to be loaded to the RAM 103
Storage device 105 storing therein the program group 104
Drive 106 that performs reading and writing on a storage medium 110 outside the information processing device
Communication interface 107 connecting to a communication network 111 outside the information processing device
Input/output interface 108 for performing input/output of data
Bus 109 connecting the respective constituent elements

The image processing device 100 can construct, and can be equipped with, an image generation means 121 and a detection means 122 illustrated in FIG. 9 through acquisition and execution of the program group 104 by the CPU 101. Note that the program group 104 is stored in the storage device 105 or the ROM 102 in advance, and is loaded to the RAM 103 and executed by the CPU 101 as needed. Further, the program group 104 may be provided to the CPU 101 via the communication network 111, or may be stored on the storage medium 110 in advance and read out by the drive 106 and supplied to the CPU 101. However, the image generation means 121 and the detection means 122 may be constructed by dedicated electronic circuits for implementing such means.

Note that FIG. 8 illustrates an example of the hardware configuration of the information processing device that is the image processing device 100. The hardware configuration of the information processing device is not limited to that described above. For example, the information processing device may be configured of part of the configuration described above, such as without the drive 106.

The image processing device 100 executes the image processing method illustrated in the flowchart of FIG. 10, by the functions of the image generation means 121 and the detection means 122 constructed by the program as described above.

As illustrated in FIG. 10, the image processing device 100 executes the processing to
generate a difference image that represents a difference between an object image that is an image of an area from which a mobile body is to be detected and a corresponding image that is another image of an area corresponding to the area of the object image (step S101), and
detect the mobile body from the object image on the basis of the object image, the corresponding image, and the difference image (step S102).

Since the present invention is configured as described above, by using an object image from which a mobile body is to be detected, a background image, and a difference image thereof, it is possible to detect a mobile body with high accuracy while suppressing an influence of an area that is different from the place to which the mobile body can move or an object existing in such an area.

Note that the program described above can be supplied to a computer by being stored in a non-transitory computer-readable medium of any type. Non-transitory computer-readable media include tangible storage media of various types. Examples of non-transitory computer-readable media include magnetic storage media (for example, flexible disk, magnetic tape, and hard disk drive), magneto-optical storage media (for example, magneto-optical disk), a CD-ROM (Read Only Memory), a CD-R, a CD-R/W, and semiconductor memories (for example, mask ROM, PROM (Programmable ROM), EPROM (Erasable PROM), a flash ROM, and a RAM (Random Access Memory)). Note that the program may be supplied to a computer by being stored in a transitory computer-readable medium of any type. Examples of transitory computer-readable media include electric signals, optical signals, and electromagnetic waves. A transitory computer-readable medium can be supplied to a computer via a wired communication channel such as a wire and an optical fiber, or a wireless communication channel.

While the present invention has been described with reference to the exemplary embodiments described above, the present invention is not limited to the above-described embodiments. The form and details of the present invention can be changed within the scope of the present invention in various manners that can be understood by those skilled in the art. Further, at least one of the functions of the image generation means 121 and the detection means 122 described above may be carried out by an information processing device provided and connected to any location on the network, that is, may be carried out by so-called cloud computing.

### <Supplementary Notes>

The whole or part of the exemplary embodiments disclosed above can be described as the following supplementary notes. Hereinafter, outlines of the configurations of an image processing method, an image processing device, and a program, according to the present invention, will be described. However, the present invention is not limited to the configurations described below.

### (Supplementary Note 1)

An image processing method comprising:
generating a difference image representing a difference between an object image and a corresponding image, the object image being an image including an area from which a mobile body is to be detected, the corresponding image being another image including an area corresponding to the area of the object image; and detecting the mobile body from the object image on a basis of the object image, the corresponding image, and the difference image.

### (Supplementary Note 2)

The image processing method according to supplementary note 1, further comprising
detecting the mobile body on a basis of a luminance value of a pixel in a specific area specified according to a predetermined criterion from an area included in each of the object image, the corresponding image, and the difference image.

### (Supplementary Note 3)

The image processing method according to supplementary note 2, further comprising
setting an extended exclusion area that is generated by extending an exclusion area specified according to a predetermined criterion from an area included in each of the object image, the corresponding image, and the difference image, and determining a residual area in which the extended exclusion area is removed from the area included in each of the object image, the corresponding image, and the difference image, to be the specific area.

### (Supplementary Note 4)

The image processing method according to supplementary note 2 or 3, further comprising
for the specific areas included in the object image, the corresponding image, and the difference image respectively, generating distributions of luminance values of pixels in the respective specific areas, and detecting the mobile body on a basis of the distributions generated for the respective specific areas.

### (Supplementary Note 5)

The image processing method according to supplementary note 4, further comprising
on the basis of the distributions generated for the respective specific areas included in the object image, the corresponding image, and the difference image, generating transformed images that are images from which the specific areas are detectable for the object image, the corresponding image, and the difference image respectively, and extracting the mobile body on a basis of the generated transformed images.

### (Supplementary Note 6)

The image processing method according to supplementary note 5, further comprising
on the basis of the distributions generated for the respective specific areas included in the object image, the corresponding image, and the difference image, setting thresholds of luminance values for binarizing the object image, the corresponding image, and the difference image respectively, generating the transformed images obtained by binarizing the object image, the corresponding image, and the difference image respectively with use of the thresholds, and extracting the mobile body on the basis of the generated transformed images.

### (Supplementary Note 7)

The image processing method according to supplementary note 5 or 6, further comprising
on the basis of each of the transformed images, determining whether or not a pixel in the transformed image is the specific area, and extracting the mobile body on a basis of a determination result.

### (Supplementary Note 8)

The image processing method according to any of supplementary notes 5 to 7, further comprising
on the basis of the respective transformed images, detecting a pixel determined that the pixel is not the specific area in the object image, that the pixel is the specific area in the corresponding image, and that the pixel has a change in a luminance value in the difference image, and extracting the mobile body on a basis of the detected pixel.

### (Supplementary Note 9)

The image processing method according to any of supplementary notes 2 to 8, wherein
the specific area is a water area. (Supplementary Note 10)

An image processing device comprising:
image generation means for generating a difference image representing a difference between an object image and a corresponding image, the object image being an image including an area from which a mobile body is to be detected, the corresponding image being another image including an area corresponding to the area of the object image; and
detection means for detecting the mobile body from the object image on a basis of the object image, the corresponding image, and the difference image.

### (Supplementary Note 11)

The image processing device according to supplementary note 10, wherein
the detection means detects the mobile body on a basis of a luminance value of a pixel in a specific area specified according to a predetermined criterion from an area included in each of the object image, the corresponding image, and the difference image.

### (Supplementary Note 12)

The image processing device according to supplementary note 11, wherein the detection means sets an extended exclusion area that is generated by extending an exclusion area specified according to a predetermined criterion from an area included in each of the object image, the corresponding image, and the difference image, and determines a residual area in which the extended exclusion area is removed from the area included in each of the object image, the corresponding image, and the difference image, to be the specific area.

### (Supplementary Note 13)

The image processing device according to supplementary note 11 or 12, wherein
for the specific areas included in the object image, the corresponding image, and the difference image respectively, the detection means generates distributions of luminance values of pixels in the respective specific areas, and detects the mobile body on a basis of the distributions generated for the respective specific areas.

### (Supplementary Note 14)

The image processing device according to supplementary note 13, wherein on the basis of the distributions generated for the respective specific areas included in the object image, the corresponding image, and the difference image, the detection means generates transformed images that are images from which the specific areas are detectable for the object image, the corresponding image, and the difference image respectively, and extracts the mobile body on a basis of the generated transformed images.

### (Supplementary Note 15)

The image processing device according to supplementary note 14, wherein on the basis of the distributions generated for the respective specific areas included in the object image, the corresponding image, and the difference image, the detection means sets thresholds of luminance values for binarizing the object image, the corresponding image, and the difference image respectively, generates the transformed images obtained by binarizing the object image, the corresponding image, and the difference image respectively with use of the thresholds, and extracts the mobile body on the basis of the generated transformed images.

### (Supplementary Note 16)

The image processing device according to supplementary note 14 or 15, wherein
on the basis of each of the transformed images, the detection means determines whether or not a pixel in the transformed image is the specific area, and extracts the mobile body on a basis of a determination result.

### (Supplementary Note 17)

The image processing device according to any of supplementary notes 14 to 16, wherein
on the basis of the respective transformed images, the detection means detects a pixel determined that the pixel is not the specific area in the object image, that the pixel is the specific area in the corresponding image, and that the pixel has a change in a luminance value in the difference image, and extracts the mobile body on a basis of the detected pixel.

### (Supplementary Note 18)

A computer-readable medium storing thereon a program for causing an information processing device to realize:
image generation means for generating a difference image representing a difference between an object image and a corresponding image, the object image being an image including an area from which a mobile body is to be detected, the corresponding image being another image including an area corresponding to the area of the object image; and
detection means for detecting the mobile body from the object image on a basis of the object image, the corresponding image, and the difference image.

### REFERENCE SIGNS LIST

10 image processing device
11 difference image generation unit
12 binary image generation unit
13 candidate pixel extraction unit
14 mobile body detection unit
15 focused image storage unit
16 background image storage unit
17 difference image storage unit
18 geographic information storage unit
100 image processing device
101 CPU
102 ROM
103 RAM
104 program group
105 storage device
106 drive
107 communication interface
108 input/output interface
109 bus
110 storage medium
111 communication network
121 image generation means
122 detection means

What is claimed is:

1. An image processing method comprising:
generating a difference image representing a difference between an object image and a corresponding image, the object image being an image including an area from which a mobile body is to be detected, the corresponding image being another image including an area corresponding to the area of the object image; and
detecting the mobile body from the object image on a basis of the object image, the corresponding image, and the difference image.

2. The image processing method according to claim 1, further comprising detecting the mobile body on a basis of a luminance value of a pixel in a specific area specified according to a predetermined criterion from an area included in each of the object image, the corresponding image, and the difference image.

3. The image processing method according to claim 2, further comprising setting an extended exclusion area that is generated by extending an exclusion area specified according to a predetermined criterion from an area included in each of the object image, the corresponding image, and the difference image, and determining a residual area in which the extended exclusion area is removed from the area included in each of the object image, the corresponding image, and the difference image, to be the specific area.

4. The image processing method according to claim 2, further comprising
for the specific areas included in the object image, the corresponding image, and the difference image respectively, generating distributions of luminance values of pixels in the respective specific areas, and detecting the mobile body on a basis of the distributions generated for the respective specific areas.

5. The image processing method according to claim 4, further comprising
on the basis of the distributions generated for the respective specific areas included in the object image, the corresponding image, and the difference image, generating transformed images that are images from which the specific areas are detectable for the object image, the corresponding image, and the difference image respectively, and extracting the mobile body on a basis of the generated transformed images.

6. The image processing method according to claim 5, further comprising
on the basis of the distributions generated for the respective specific areas included in the object image, the corresponding image, and the difference image, setting thresholds of luminance values for binarizing the object image, the corresponding image, and the difference image respectively, generating the transformed images obtained by binarizing the object image, the corresponding image, and the difference image respectively with use of the thresholds, and extracting the mobile body on the basis of the generated transformed images.

7. The image processing method according to claim 5, further comprising
on the basis of each of the transformed images, determining whether or not a pixel in the transformed image is the specific area, and extracting the mobile body on a basis of a determination result.

8. The image processing method according to claim 5, further comprising
on the basis of the respective transformed images, detecting a pixel determined that the pixel is not the specific area in the object image, that the pixel is the specific area in the corresponding image, and that the pixel has a change in a luminance value in the difference image, and extracting the mobile body on a basis of the detected pixel.

9. The image processing method according to claim 2, wherein the specific area is a water area.

10. An image processing device comprising:
at least one memory configured to store instructions; and
at least one processor configured to execute instructions to:
generate a difference image representing a difference between an object image and a corresponding image, the object image being an image including an area from which a mobile body is to be detected, the corresponding image being another image including an area corresponding to the area of the object image; and
detect the mobile body from the object image on a basis of the object image, the corresponding image, and the difference image.

11. The image processing device according to claim 10, wherein the at least one processor is configured to execute the instructions to
detect the mobile body on a basis of a luminance value of a pixel in a specific area specified according to a predetermined criterion from an area included in each of the object image, the corresponding image, and the difference image.

12. The image processing device according to claim 11, wherein the at least one processor is configured to execute the instructions to
set an extended exclusion area that is generated by extending an exclusion area specified according to a predetermined criterion from an area included in each of the object image, the corresponding image, and the difference image, and determine a residual area in which the extended exclusion area is removed from the area included in each of the object image, the corresponding image, and the difference image, to be the specific area.

13. The image processing device according to claim 11, wherein the at least one processor is configured to execute the instructions to,
for the specific areas included in the object image, the corresponding image, and the difference image respectively, generate distributions of luminance values of pixels in the respective specific areas, and detect the mobile body on a basis of the distributions generated for the respective specific areas.

14. The image processing device according to claim 13, wherein the at least one processor is configured to execute the instructions to,
on the basis of the distributions generated for the respective specific areas included in the object image, the corresponding image, and the difference image, generate transformed images that are images from which the specific areas are detectable for the object image, the corresponding image, and the difference image respectively, and extract the mobile body on a basis of the generated transformed images.

15. The image processing device according to claim 14, wherein the at least one processor is configured to execute the instructions to,
on the basis of the distributions generated for the respective specific areas included in the object image, the corresponding image, and the difference image, set thresholds of luminance values for binarizing the object image, the corresponding image, and the difference image respectively, generate the transformed images obtained by binarizing the object image, the corresponding image, and the difference image respectively with use of the thresholds, and extract the mobile body on the basis of the generated transformed images.

16. The image processing device according to claim 14, wherein the at least one processor is configured to execute the instructions to,
on the basis of each of the transformed images, determine whether or not a pixel in the transformed image is the specific area, and extract the mobile body on a basis of a determination result.

17. The image processing device according to claim 14, wherein the at least one processor is configured to execute the instructions to,
on the basis of the respective transformed images, detect a pixel determined that the pixel is not the specific area in the object image, that the pixel is the specific area in the corresponding image, and that the pixel has a change in a luminance value in the difference image, and extract the mobile body on a basis of the detected pixel.

18. A non-transitory computer-readable medium storing thereon a program comprising instructions for causing an information processing device to execute processing to:
generate a difference image representing a difference between an object image and a corresponding image, the object image being an image including an area from which a mobile body is to be detected, the corresponding image being another image including an area corresponding to the area of the object image; and
detect the mobile body from the object image on a basis of the object image, the corresponding image, and the difference image.

19. The image processing device according to claim 11, wherein
the specific area is a water area.
